(19) United States
(12) Patent Application Publication
(10) Pub. No.: US 2024/0334885 A1
(43) Pub. Date: Oct. 10, 2024

(54) Habbag Natural fibre Planter Bag -Pot and Geotextile fabric

(71) Applicants: Jean-Michel Libeau, Wanaka (NZ); Sarah Elizabeth Johnston, Oxford (NZ)

(72) Inventors: Jean-Michel Libeau, Wanaka (NZ); Sarah Elizabeth Johnston, Oxford (NZ)

(21) Appl. No.: 18/052,152

(22) Filed: Nov. 2, 2022

(30) Foreign Application Priority Data
Mar. 15, 2022 (NZ) PT786217

(51) Int. Cl. A01G 9/029; A01C 21/00; D04H 1/425; D04H 1/4382; D06M 13/224; D06M 101/06

(52) U.S. Cl. CPC A01G 9/0291; A01C 21/00; D04H 1/425; D04H 1/43835; D06M 13/2246; D06M 2101/06; D06M 2200/12; D10B 2401/12; D10B 2505/10; D10B 2505/204

(57) ABSTRACT

The invention relates to a non-woven textile fabric of one or a combination of wool, hemp, cotton, cellulose and or other natural fibres, treated with a natural water proofing and fungicide solution for planter bags and pots. The planter bag or pot fabric enables superior air pruning of the plant roots. The bag or pot can be directly planted into the ground with the plant and biodegrades.

### TECHNICAL FIELD

The invention relates to natural fibre non-woven fabric planter bags and pots used in the nursery/horticultural industry.

### BACKGROUND OF THE INVENTION

It is known that planter bags and pots are extensively used in the nursery and horticultural industry for the growing of trees, shrubs, and seedlings. These planter bags and pots are traditionally made from synthetic man-made fibres and materials which are now a significant environmental problem because they are non-recyclable and are an environmental issue due to micro plastics being released into the environment.

This natural fibre technology has led to the development of new fabrics with the application of a natural water-resistant material for use in planter bags, pots and liners. The fabric creates additional benefits of being biodegradable and provides the additional benefit of air pruning the plants root system. Air pruning of the plant leads to these benefits. The applicants have discovered that when the roots grow through the wall of the bag and pot, they are air pruned. This causes the roots to callus and form small nodules, which then, when the plant is put in the ground it sends out multiple new roots, creating a more fibrous root system leading to better plant survival. The bag and pot fabric also encourages a more fibrous root system within the bag-pot.

The applicants have discovered that by using natural fibres which enable air pruning, the plant no longer has root girdling issues around the inside of the bag-pot causing the plant to ultimately strangle itself. It is therefore an objective of the invention to provide a system for producing non-woven fabrics having different fibre structures and natural water resistant, or to at least provide a useful alternative to existing planter bag and pot systems

### SUMMARY OF THE INVENTION

Using a non-woven fabric comprising of one or a combination of wool, hemp, cotton, cellulose and or other natural fibres to specified fibre percentages, fabric weight and density for the construction of the Planter Bags. To enable the fabric and planter bag and pots to withstand the requirements within the nursery environment, a natural water repellent and fungicide material is applied to the fabric.

### BRIEF DESCRIPTION OF THE FIGURES,

Preferred embodiments of the invention will be described by way of example only and with reference to the photos, in which:

FIG. 1 is the planter bag

FIG. 2 is air-pruning of the roots

FIG. 3 Hemp Wool bag fabric

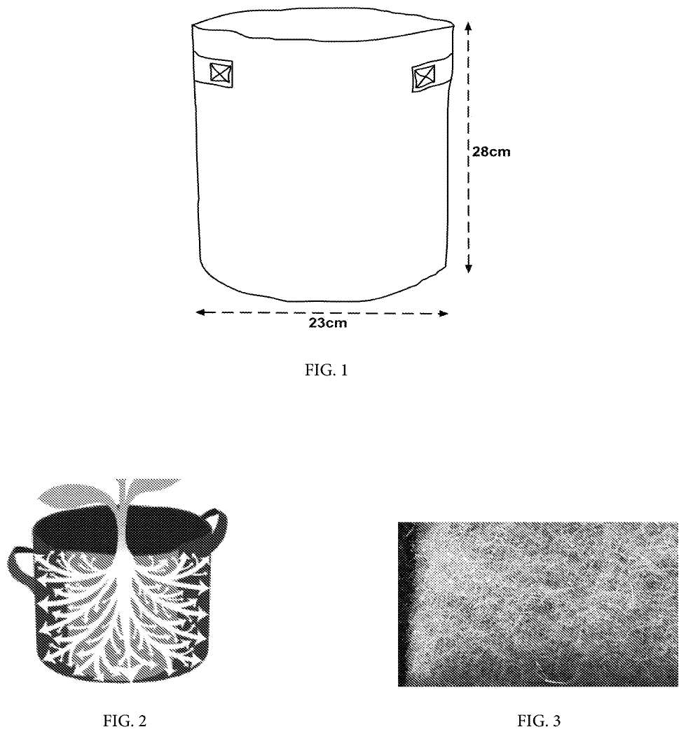

### DETAILED DESCRIPTION

The invention relates to a fabric for use when producing planter bags/pots and liners.

The fabric is configured to set percentages of staple fibres blended and formed into a non-woven fabric from 250-2000 gsm (grams per square meter) during the needle punching process.

The staple fibres may be short staple fibres or long staple fibres. The staple fibres may include, but are not limited to wool, hemp, cotton, cellulose and or other natural fibres.

The water proofing solution is configured from at least two natural materials.

The water proofing solution may be wool grease, vegetable plant-based oils and a natural fungicide being but not limited to Copper Sulphate or Sulphur.

This water proofing solution will be applied to the non-woven fabric by a textile Padding System and the excess solution removed by Mangle rollers. The fabric passes through the application process applying a set amount of solution to provide water and fungal resistance to the non-woven fabric.

The fabric is used to make a planter bag/pot and liner which has air pruning properties. The fabric construction and solution enable the plants roots to penetrate the bag wall and enabling air-pruning of the roots. Because the planter bag is made from natural fibres, when the roots of the plant hit the inside wall of the bag, they can grow through it. When the roots reach the outer side of the bag and meet the air they stop growing. This causes the roots to callus and form small nodules, which then, when the plant is planted in the ground in the bag it sends out multiple new roots, creating a more fibrous root system leading to better plant survival. Another benefit of this development is that this process also encourages the plant to produce more roots inside the bag creating a more fibrous root system within the bag. Because the plant is planted without removing the bag there is no root disturbance at planting time, there for no after planting shock. The natural fibre bag/pot will bio-degrade as the plant grows.

1. Combining natural fibers of one or a combination of wool, hemp, cotton, cellulose and or other natural fibres at set percentages to produce a non-woven fabric that is used for the manufacturing of planter bags and pots.

2. Application of a water proofing solution made from wool grease and natural fungicides, extends the life of the non-woven fabric bag in the nursery environment.

3. The fabric according to claims 1 and 2 where in the first and second process combined to form the finished fabric are used for planter bag and pot use.

4. The fabric according to claims 1 and 2 where in the first and second process combined to form a suitable fabric for air pruning trees, shrubs and plants.

5. The natural fabric according to claims 1 and 2 enables even, fibrous root structure throughout the planter bag enabling superior air pruning.

6. The tree, shrub or plant can be directly planted in the ground whilst still in the natural fiber planter bag or pot.

7. The natural fiber planter bag, planted directly into the ground with the plant, enables superior root growth and plant establishment.

8. The bag according to claims 1 and 2 made of natural products biodegrades in the ground becoming organic material.

9. As the bag biodegrades it releases nutrients to the growing plant. Examples of these nitrogen, Sulphur, sodium, potassium, and magnesium. These nutrients are naturally released into the soil over time.
